(19) United States
(12) Patent Application Publication
(10) Pub. No.: US 2011/0088530 A1
(43) Pub. Date: Apr. 21, 2011

(54) CHEESE/FOOD EXTRUSION CUTTING DIE BLADE, PROCESS OF USE AND PROCESS OF PRODUCTION

(76) Inventors: William C. Arbaugh, II, New Albany, IN (US); Laurie M. Arbaugh, New Albany, IN (US)

(21) Appl. No.: 12/906,664

(22) Filed: Oct. 18, 2010

Related U.S. Application Data
(60) Provisional application No. 61/252,660, filed on Oct. 17, 2009.

(51) Int. Cl. A23P 1/10; B26D 1/03

(52) U.S. Cl. 83/857; 426/518

(57) ABSTRACT

A process for the precision cutting of food products including large blocks of cheese or processed meats utilizing a cutting die formed from a solid metal blank, wherein the cutting die is created in a pattern which includes shaped cutting edges which are then processed to form knife edges for the cutting of the food products and the extrusion cutting die used for this process.

### RELATED APPLICATION

This application claims priority from U.S. provisional application Ser. No. 61/252,660, filed on the 17^{th} of Oct. 2009.

### FIELD OF THE INVENTION

One embodiment of the invention includes a device used for the precision cutting of food products, such as large blocks of cheese or processed meats, utilizing an extrusion cutting die blade produced from a solid metal blank, wherein the cutting edges of the metal blank are formed into an unique shape and cross section for the precise cutting of the food products. Another embodiment is a process of use of the cutting die blade. A further embodiment is a process of preparation of the cutting die blade.

### BACKGROUND OF INVENTION

An ongoing goal in the food/cheese/processed meat industry is to find commercially profitable methods to produce food products that have unique shapes and/or cross sections. For example, novelty cheese or processed meat products may be produced in the shape of a heart or a four-leaf clover for holiday sales.

It is difficult to produce these shapes in food products using a conventional extrusion process, particularly for large sections or tubes of food. For example, cheeses and processed meats are generally manufactured in relatively large cylinders or blocks and cut for sale into smaller blocks or chunks selected according to consumer preference. These food products are sometimes sold in cylindrical or rectangular shapes or in slices, which are cut from those forms.

In the prior art, cheese has been cut into smaller blocks by using thin cutting wires suspended from the perimeter of metal blanks by means of adjustable set screws. These wires have been arranged primarily in geometric shapes. Elaborate shapes for these cut food products have not been possible by using this wire cutting method.

In addition, attempts to produce precisely shaped cheese or processed meat products by extrusion also has not been successful. One problem that has occurred is that the use of cutting wires to cut the food products into the desired shapes does not produce accurately shaped products. These wires, being flexible, deform from the hydraulic pressure used to push the uncut blocks of the food product through the wire assemble. In addition, presently used cutting wires do not actually cut the food product. Many physical characteristics of food and food products are highly variable. Viscosity, density, hardness, cutting resistance, texture and temperature requirements are but a few of the variables that must be taken into account in determining the correct equipment necessary to achieve the desired shapes. For example, the friction from hydraulic pressure creates a small fracture or tear on the surface of the food product just behind the cutting wire before the food product passes through the wire pattern. This often results in an undesirable irregular surface on the resulting cut sections of the food product. Other problems caused by the use of wire includes plastic deformation and deleterious effects from surface tension.

Accordingly, it is one object of an embodiment of the invention to produce a method for precisely cutting a food product to achieve precise shapes. Using this embodiment the food product can be precisely shaped as it passes through an embodiment of the invention resulting in highly accurately shaped pieces of food products.

Another embodiment of the invention permits elaborate cutting patterns to be formed in the food products. Such patterns, which may be possible using the proposed equipment, includes, but is not limited to, compound curves, arches and other precise shapes. Such shapes can not be produced from the current wire cutting process.

Another embodiment of the invention is a process for forming the equipment used to make those precision cuts in the food products.

A further embodiment is a uniquely designed and shaped cutting die blade produced from a solid metal blank to be used to precisely cut shapes into food products, such as cheeses or processed meats.

These and other objects of the invention will be apparent from the detailed description hereafter.

### SUMMARY OF INVENTION

In accordance with the present invention, an extrusion or cutting die blade is provided for forming precisely shaped food products without substantial damage to the surface of the food product due to working an irregular form under pressure. The extrusion or cutting blade is produced from a solid metal blank of an appropriate thickness, depending upon the type of food product that is to be cut. An unique pattern is cut into the metal blank resulting in a series of thin cutting edges in the two outside surfaces of the cutting die blade. The previously designed pattern is cut through the entire metal blank. These cutting edges are further processed to form uniquely shaped, knife edges with a reduced cross section that cut the food product. By use of these uniquely shaped, knife edges, the pressure is reduced, resulting in the formation of uniquely shaped food products when the food products is passed through shaped knife edges of the die blade.

Also provided are processes for production of the cutting blade and processes of use of cutting die blade to cut food products, such as cheese or processed meats.

### BRIEF DESCRIPTION OF THE DRAWINGS

The various objects and features of the present invention will be more fully understood by reference to the accompanying drawings.

FIG. 1 is a perspective view of a machined metal blank, with applied machined cutting edges exhibiting a series of heart-shaped cutting-edge openings in a die blade.

FIG. 2 is a top view of the cutting blade shown in FIG. 1.

FIG. 3 is a bottom view of the cutting blade shown in FIG. 1.

FIG. 4 is a side view of the cutting blade shown in FIG. 1.

FIG. 5 is a perspective view of the machined metal blank of FIG. 1, further including rib elements and shaped knife edges of the die blade.

FIG. 6 is a perspective, inset view of a portion of the die blade of FIG. 1, further including a series of depressions in the cutting edges of the die blade.

FIG. 7 is a cross section view of alternative shapes of the knife edges of the die blade.

### DETAILED DESCRIPTION OF AN EMBODIMENT OF THE INVENTION

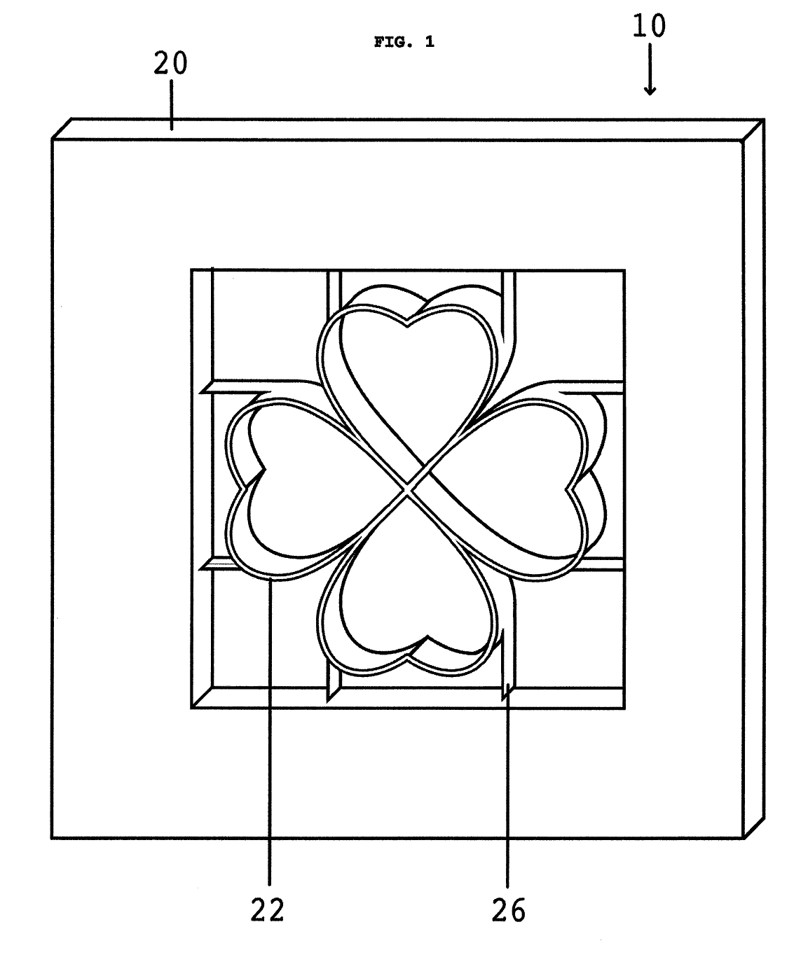

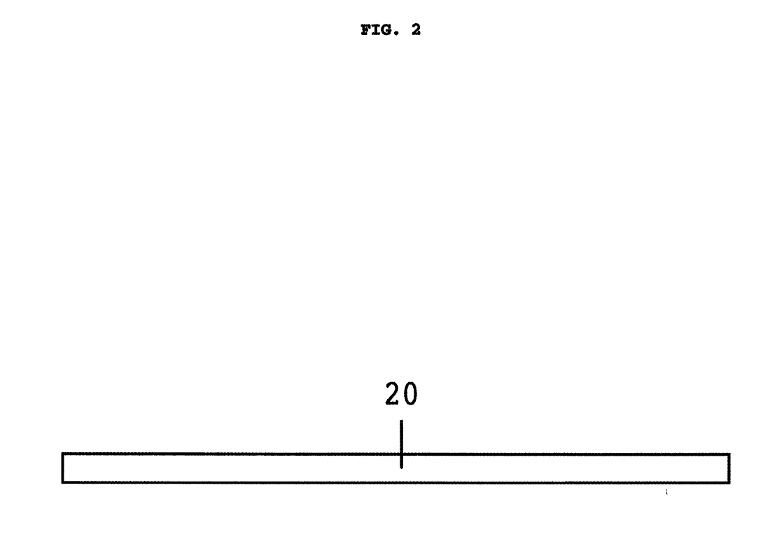

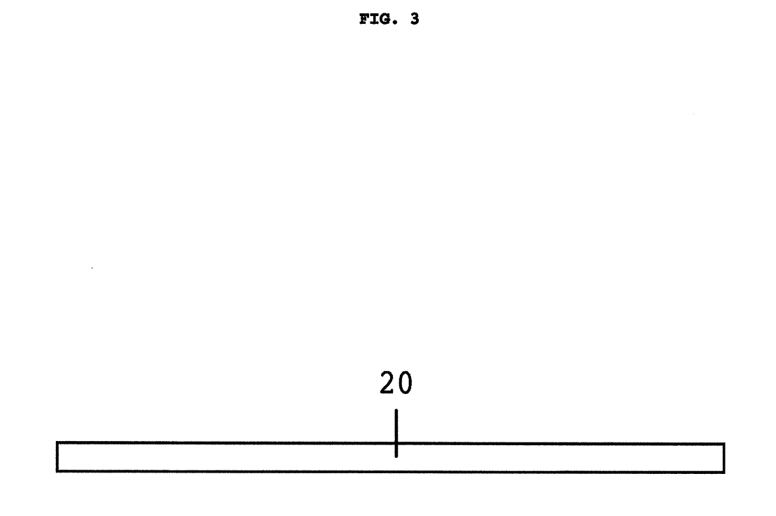

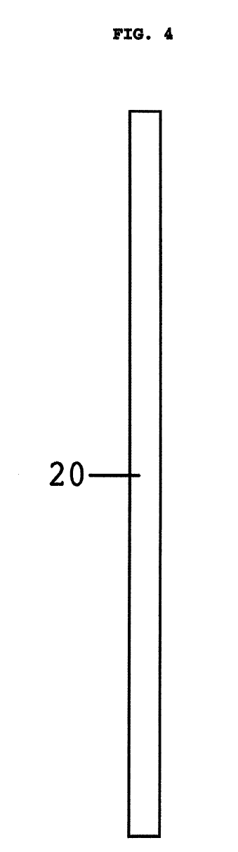

This invention relates to a new type of cutting die blade (10) for the shaping of food and food products, methods for using the cutting die blade and processes for preparation of the cutting die blade, as shown in FIGS. 1 through 7.

Specifically, the invention provides a new type of cutting die blade (10) for shaping food and food products. In one embodiment, this new cutting die blade is machined using a wire electrical discharge machine on the leading edge of a patterned die, the patterned openings of which have also been cut using, among acceptable processes, a wire electrical discharge machine from a food grade stainless steel metal blank (20). See FIG. 1.

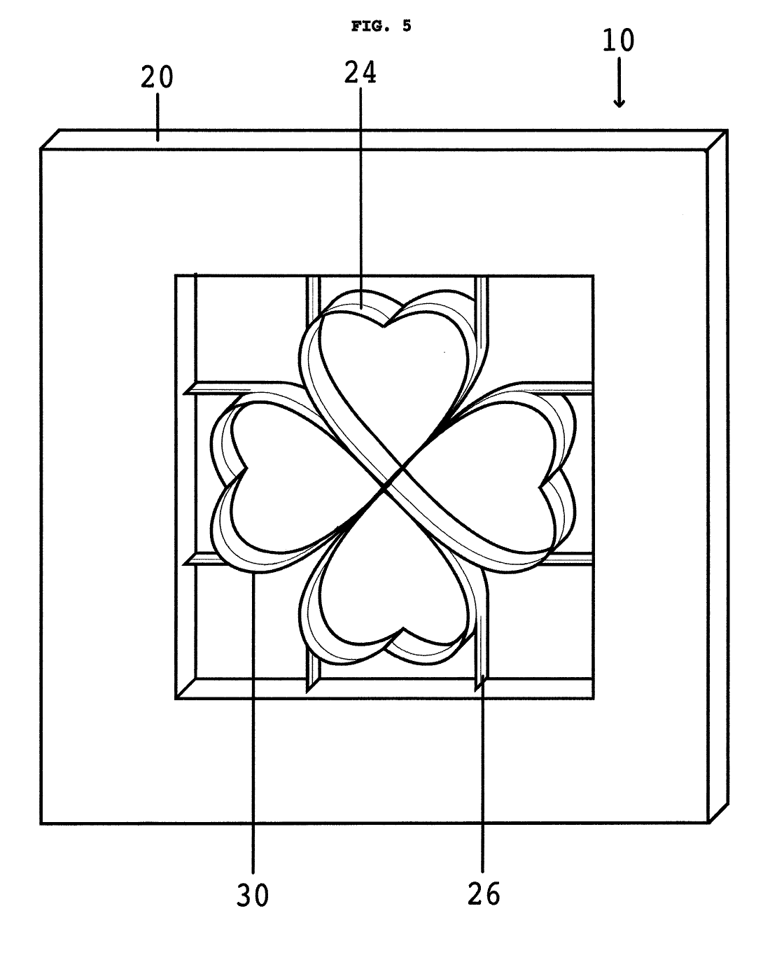

These cutting die blades (10), created with this process of machining, are further treated such that cutting edges (24) of the cutting die blade are modified to form uniquely shaped knife edges (30) that may then be used to shape food and food products. The process includes the following process steps. See FIG. 5.
Designing a pattern that incorporates any or all of the desired shapes with which the food and food products is to be shaped, while allowing for negative space around the desired shapes, said negative space allows the unwanted parts of the food being shaped to fall away;
Cutting this pattern into a solid, food grade stainless steel metal blank (20) of an appropriate thickness (the thickness of the shaping die walls (22) of the metal blank depends upon the type of food or food product to be cut), using, for example, a wire electrical discharge machine;
Cutting the desired pattern into the metal blank (20) resulting in a series of cutting edges (24), attached to surfaces of the metal blank, which cutting edges can further comprise ribs (26), to support the cutting edges (24) in the metal blank;
Machining the cutting edges (24) to an appropriate type, size, depth, thickness and angle on either or both sides of the extrusion cutting die blade to form knife edges (30) used to cut the food product; and
Applying an appropriate surface treatment, if necessary, to the knife edges (30) or the entire die blade (10) to allow the food or food products to be cut into the desired shape and resulting in the peculiar characteristics caused by the chosen cutting edge and treatment.

In one embodiment the steps of the process for production of the extrusion die blade (10) with cutting edges (24) formed into unique knife edges (30) are as follows:

A pattern is designed, which describes the position and shape of the cutting edges (24) of the cutting die blade that produces a desired shape that results, when passing a food or food product through a metal blank (20), that has had the pattern machined into it. This pattern must be designed to take into account the properties of the food to be shaped as it passes through the pattern.

The metal blank may be made of any food grade stainless steel, preferably Grade 420, to meet required minimum federal and state food safety standards. Grade 420 is preferred as it is a higher carbon version of Grade 410. Like most non-stainless steels, it can be hardened by heat treatment. It contains a minimum of 12 percent chromium, which is sufficient to give critical corrosion resistance properties. It has good ductility in an annealed condition but is capable of being hardened up to Rockwell Hardness 50HRC, the highest hardness of the 12 percent chromium grades. Its best corrosion resistance is achieved when the metal is hardened. Related grades to 420 are high carbon, high hardness martensitic stainless steels, such as the 440 series, and variations to the 420 series that contain molybdenum (for increased corrosion resistance), sulphur (for increased machinability) or vanadium (for higher hardness). A slightly higher carbon version of 420 is the non-standard grade 420C.

Factors to consider in the creation of the pattern include the necessary thickness of the cutting die blade (10) design, the arrangement of the pattern(s) to provide required strength to the die when the pattern is cut into the metal blank (20), and the shape of any food that to be removed in the shaping process.

The food-grade stainless steel metal blank (20) should be of sufficient thickness for strength and is large enough to accept the desired pattern, including any additional surface area required for mounting, is placed in a CNC controlled wire electrical discharge machine (EDM). The wire EDM process used in the invention is well suited for the martensitic stainless steel series as the metal is optimized for high hardness, allowing for clean EDM cutting and a final hardening step through a temper heat treatment. This grade is commonly used for cutlery—particularly the blades of table knives and carving knives. In one preferred embodiment for forming designs for conventional cheeses or processed meats, the metal blanks should be from about 0.5 to about 3 cm, or so, in thickness.

The pattern designed above is used to control the cutting of the design into the metal blank (20) by the EDM machine. In wire electrical discharge machining, a thin single-strand metal wire, usually brass, is fed through the food-grade stainless steel metal blank, submerged in a tank of dielectric fluid, typically de-ionized water. The wire, which is constantly fed from a spool, is held between upper and lower diamond guides. The guides move in the x-y plane. The upper guide can also move independently in the z-u-v axis, giving rise to the ability to cut tapered and transitioning shapes.

The wire-cut process uses water as its dielectric fluid, controlling its resistance and other electrical properties with filters and de-ionizer units. The water flushes the cut debris away from the cutting zone. A small hole is drilled in a pre-determined location, allowing the EDM machine to cut away that portion of the desired patterned opening. This process is repeated, as many times as there are openings in the desired pattern. For example one such pattern is shown in FIG. 1, which shows a series of heart-shaped cutting edges.

This step creates a metal blank (20) with the required openings described by the pattern. This wire-cut process forms a cutting die (10) with a pattern of cutting edges (24) cut into the metal blank which pattern extends through the metal blank forming two outside surfaces (28). See FIG. 1. The resulting cutting edges of the cutting die blade (10) at this stage in the process are not yet useful in processing food and food products into shapes. As mentioned above, untreated cutting edges (24) of this type of wire EDM cut metal blank are not suitable for processing the food and food products, as untreated machined edges cause the food or food product to tear, fracture and accumulate on and around the untreated edges as the food is passed through the machined blank.

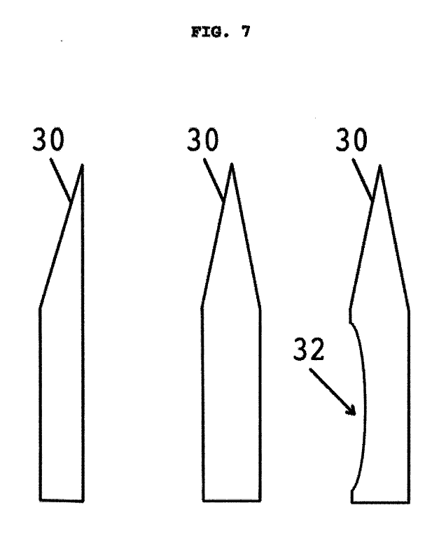

To prepare the cutting edges (24) for use as the die blade (10), the cross section of the cutting edges is reduced and the remaining portion of the cutting edges are sharpened to form the knife edges (30) as shown in FIG. 5. Particular preferred shapes of knife edges (30) depend on the food product to be processed. Examples of preferred embodiments of these shapes of the knife edges are shown in FIG. 7.

One embodiment of the invention requires further careful consideration during the design process. One advantage of an embodiment of the invention is that the process allows for clean, smooth shaping of the food product passed through the cutting die blade. One aspect of an embodiment of the invention is that the food to be shaped is initially introduced to just leading sharpened knife edges (30) of the cutting die blade (10), with no contact from any supporting ribs (26) that support the delicate cutting pattern within the machined opening of the stainless steel blank (20).

To achieve this advantage requires moving the ribs (26) of the support structure away and behind the leading knife edges (30) of the shaping die blade (10) to produce a clean, initial shape to be formed by the cutting die blade. When the ribs of the support structure are on the same plane as the knife edges of the cutting die blade, the food product often tears, fractures and builds up at the intersection of the support structure and the cutting edge. A smooth, clean shape is introduced along the length of the food product, with any build up of removed food product taking place behind and away from the shaped food as it passes through and moves away from the knife edges of the cutting die blade. To achieve this smooth clean shape requires moving the ribs (26) of the support structure at least about 10% of the overall thickness of the metal blank away from the surface of the cutting die blade and preferably at least about 30% of the overall thickness of the metal blank. See FIG. 5.

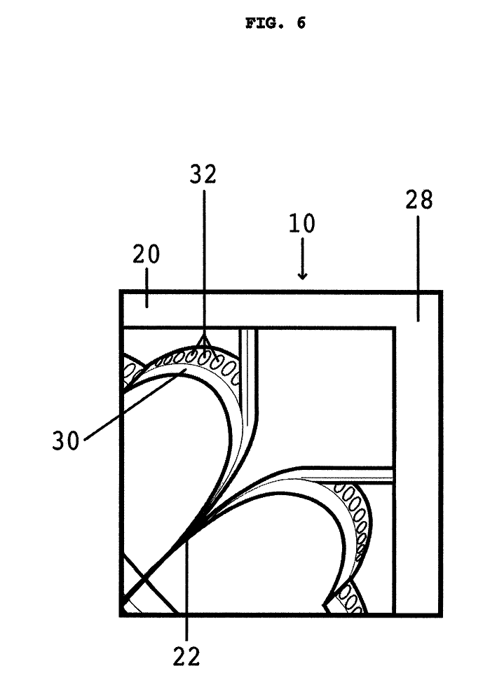

This embodiment's performance is also improved with a smooth thin surface finish on the sides of the pattern, as shown in FIG. 5, and with a series of depressions (32), preferably concave in shape, cut into one or both sides of the knife edges (30) as shown in FIG. 6. These depressions create a void between the food product and the sidewalls of the cutting die assembly. These depressions eliminate friction where they are located as there is no physical contact between the food and the cutting die blade (10) at those points. The frequency, width, depth and placement of the depressions depend on the physical properties of the food to be shaped. The greater the frequency and width of the depressions directly lowers the total friction acting upon the food as it is being shaped. The net result of cutting the depressions into the sidewall of the knife edges of the cutting die blade is a reduction in the total coefficient of friction that acts upon the food product as it is passed through the shaping die. In one embodiment, at least about 20% of the surface of the knife edges contain depressions.

The appropriate pattern of depressions (32) is designed at the time the wire EDM pattern is created, before the various patterns are cut into the stainless steel blank (20). Special attention is given to areas of the cutting die blade (10) pattern and the intersections of ribs (26) of the support structure members, as these areas often require more frequent or wider concave depressions in areas of high friction.

This embodiment of the invention involves treating these cutting edges (24) of a typically machined metal blank (20) by machining a predetermined, patterned knife edge (30) by stepping back a portion of the cutting edges and supporting ribs (26) and applying certain surface textures and treatments (when deemed appropriate).

This embodiment of the invention can be machined in such a way that it can be clamped or locked in position for use. The invention can also be created with a series of locating holes, slots or various other patterns for use in positioning the shaping die for use.

The advantage of the invention is that it is a new, highly accurate shaping process for food and food products.

The pattern and shape of the cutting edge claimed in this embodiment cause important results in both the accurate, efficient shaping of the desired food product as well as achieving the desired exterior surface texture on the sides of the shaped food product as it passes through the cutting edges of the edged metal blank.

Another advantage of this embodiment of the invention is that stepping back and cutting away certain edges, supporting ribs and other structural elements of the machined metal blank is a novel way to initially introduce the food or food product cleanly to the cutting surface of the cutting edges, eliminating tearing, gathering and accumulation of the food product as it passes through the cutting edges of the die.

Additionally, this embodiment of the invention of machining an unique surface pattern to the sides of the edged cutting surfaces will allow for reduced friction, quicker, more efficient throughput of the food product as it is processed, resulting in greater economies in processing using the claimed invention.

1. A precision food product cutting die comprising
a metal blank with a generally uniform thickness containing a pattern of cutting edges cut into said metal blank which extends through the metal blank forming two outside surfaces, wherein at least one surface of the cutting edges is reduced in cross section to form shaped knife edges, which shaped knife edges precisely cut food products which pass through the cutting die.

2. The cutting die of claim 1 wherein the surface of the cutting edges further comprises ribs, which support the cutting edges, wherein said ribs are inset from the surface of the cutting edges at least about 10% of an overall thickness of the cutting die.

3. The cutting die of claim 1 wherein knife edges further comprise depressions cut into one or both sides of the knife edges.

4. The cutting die of claim 3 wherein the depressions are concave in shape.

5. The cutting die of claim 2 wherein knife edges further comprise depressions cut into the knife edges.

6. The cutting die of claim 5 wherein depressions are also present in the ribs.

7. The cutting die of claim 1 wherein the knife edges of the cutting edges are formed in the shape of a heart.

8. The cutting die of claim 1 wherein the cutting edges are treated with a surface treatment to reduce friction when exposed to food products.

9. A process for the shaping of food products comprising
creating a cutting die from a metal blank by machining the metal blank to form shaped cutting edges which extend through the metal blank to form a pattern of cutting edges,
machining the cutting edges to form knife edges, whose thickness is less than the thickness of the shaped cutting edges prior to machining,
securing the cutting die to a food processing machine utilized to force a food product through the cutting die, and
forcing the food product through the cutting die to form the shaped food products.

10. The process of claim 9 further comprising surface treating the cutting edges to reduce the resistance of the food product at it is forced through the cutting die.

11. The process of claim 9 further comprising introducing depressions into one or both sides of the knife edges.

12. The process of claim 9 wherein the cutting edges of the cutting die further comprise ribs which are inset from a surface of the cutting edges.

13. The process of claim 9 wherein the food product shaped by the cutting die comprises cheese.

14. The process of claim 9 wherein the food product shaped by the cutting die comprises processed meats.
